(19) United States
(12) Patent Application Publication
(10) Pub. No.: US 2026/0156153 A1
(43) Pub. Date: Jun. 4, 2026

(54) SYSTEMS AND METHODS USING ARTIFICIAL INTELLIGENCE TO ENHANCE DATA TRANSFER SECURITY

(71) Applicant: The Toronto-Dominion Bank, Toronto (CA)

(72) Inventors: Mohit SHARMA, Toronto (CA); Hitesh BAJAJ, Duluth, GA (US); Jonathan Joseph PRENDERGAST, West Chester, PA (US); Milos DUNJIC, Oakville (CA); David Samuel TAX, Toronto (CA); Thomas Osman KELLY, Wenonah, NJ (US); Pranay Chander GUPTA, Toronto (CA); Kushank RASTOGI, Toronto (CA); Abhijit SINGHA HAZARI, Oakville (CA)

(73) Assignee: The Toronto-Dominion Bank, Toronto, ON (CA)

(21) Appl. No.: 18/964,773

(22) Filed: Dec. 2, 2024

(51) Int. Cl. H04L 9/40; G06N 20/00

(52) U.S. Cl. CPC H04L 63/20; G06N 20/00

(57) ABSTRACT

Methods and systems for enhancing data transfer security using artificial intelligence are described. In one aspect, a system or processor executes a method that includes receiving first data associated with a first data transfer. The processor may generate a first score by passing at least a portion of the first data to a scoring artificial intelligence model. The first score indicates a first priority. The first data transfer and the first score may be associated with a first pointer. The processor inserts the first pointer into a priority data structure. The processor detects a distribution trigger condition associated with an operating device. In response, the processor removes, A pointer from the priority data structure. The pointer is associated with a respective data transfer. The processor sends data associated with the respective data transfer an operating device.

### TECHNICAL FIELD

The present application relates to security applications and, more particularly, to methods and systems that use artificial intelligence such as machine learning (ML) models and generative artificial intelligence (GenAI) to enhance data transfer security.

### BACKGROUND

Vast amounts of data are transferred over wireless networks such as internet networks. Sometimes the data in transit over these wireless networks is defective, malicious, illegitimate, or otherwise problematic. For example, in a denial-of-service (DOS) attack, a perpetrator or bad actor attempts to overload a server by flooding the server with data comprising illegitimate server requests. A successful denial-of-service attack may lead to the attacked server being unable to serve legitimate client computers. In another example, defective or corrupted data in a data transfer may lead to the execution of the data transfer having unintended results. That is, for example, the execution of a data transfer with corrupted data may lead to the data not arriving at the correct or intended destination. For example, the data may be transferred to an unintended System B instead of an intended Device A. Alternatively, for example, the data may not arrive at any destination and effectively be lost. Accordingly, security tools, applications, systems, and the like are used to detect problematic data and prevent resultant issues and problems. For example, an intrusion prevention system (IPS) monitors network traffic to prevent network attacks or cyberattacks. In some circumstances, however, a server, for example, may have an amount of data transfers to process in a given time that exceeds an amount of data transfers that a corresponding or associated security system can review or check in the same given time. Further, in some of these circumstances, it may be unreasonable to delay the execution of a data transfer until that data transfer has been reviewed, checked, or cleared. For example, such a practice may lead to dissatisfied clients of the server or services associated with the server. For example, some time data transfers may be time-sensitive and the delay of the data transfer may lead to undesirable consequences for the client.

Accordingly, there is need for a system that enhances the security of data transfers while minimizing potential performance loss such as delay of service.

### BRIEF DESCRIPTION OF THE DRAWINGS

Embodiments are described in detail below, with reference to the following drawings:

FIG. 1 is a schematic operations diagram illustrating an operating environment of a system according to an example embodiment of the present disclosure;

FIG. 2 is a simplified schematic diagram showing components of an example computer device;

FIG. 3 is a high-level schematic diagram of an example computer system;

FIG. 4 shows a simplified organization of software components stored in a memory of the computer system of FIG. 3;

FIG. 5 is a schematic diagram illustrating an artificial intelligence computing environment of the server computer system of FIG. 1 according to example embodiments;

FIG. 6 is a diagram illustrating processes for training a ML model according to example embodiments;

FIGS. 7A-7C show diagrams illustrating training data for a ML model according to example embodiments;

FIGS. 8A-8B show diagrams illustrating training data for a ML model according to example embodiments;

FIGS. 9A-9C show diagrams illustrating priority data structures according to example embodiments;

FIG. 10 is a flowchart showing operations performed by the server computer system of FIG. 5 for enhancing data transfer security;

FIG. 11 is another flowchart showing other operations performed by the server computer system of FIG. 5 for enhancing data transfer security; and

FIG. 12 is yet another flow chart showing further operations performed by the server computer system of FIG. 5 for enhancing data transfer security.

Like reference numerals are used in the drawings to denote like elements and features.

### DETAILED DESCRIPTION OF VARIOUS EMBODIMENTS

In an aspect, the present application discloses a computer system including at least one processor and a memory coupled to the at least one processor and storing processor-executable instructions. When executed by the at least one processor, the instructions configure the at least one processor to: receive first data, the first data being associated with a first data transfer; generate a first score by passing at least a portion of the first data to a scoring artificial intelligence model, the first score indicating a first priority; associate the first data transfer with the first score; associate the first data transfer with a first pointer; insert the first pointer into a priority data structure that stores a plurality of pointers associated with respective data transfers and respective scores, the respective scores indicating respective priorities, the first pointer being placed in the priority data structure based on the first score; detect a distribution trigger condition associated with an operating device; remove, in response to detecting the distribution trigger condition, one pointer from the priority data structure, the respective score associated with the one pointer indicating a greater priority than the respective score associated with another pointer stored in the priority data structure; and send data associated with the respective data transfer associated with the one pointer to the operating device.

In some implementations, the at least one processor is further configured to train the scoring artificial intelligence model using training data, the training data including a plurality of labelled pairs, at least one of the plurality of labelled pairs comprising: sample data associated with a sample data transfer; and a sample score.

In some implementations, the at least one processor is further configured to train the scoring artificial intelligence model using training data, the training data including a sorted list of sample data, the sample data being associated with sample data transfers having associated sample priorities, and the sorted list being sorted according to the associated sample priorities of the sample data transfers.

In some implementations, the at least one processor is further configured to train the scoring artificial intelligence model using training data, the training data including a plurality of labelled pairs, at least one of the plurality of labelled pairs comprising: first sample data associated with a first sample data transfer; and second sample data associated with a second sample data transfer, the second sample data transfer having a greater sample priority than the first sample data transfer.

In some implementations, the at least one processor is further configured to: generate, in association with the respective data transfer of the one pointer, a respective message specific to the respective data transfer by passing data associated with the respective data transfer to an error detecting artificial intelligence model; and store, in a storage medium, the respective message in association with the respective data transfer.

In some implementations, sending data associated with the respective data transfer associated with the one pointer to the operating device further comprises: detecting that the one pointer has been removed from the priority data structure; retrieving the respective message associated with the one pointer from the storage medium; and sending the respective message to the operating device.

In some implementations, the at least one processor is further configured to: detect a trigger condition; generate, in response to detecting the trigger condition, a summary of the respective data transfers associated with at least one of the pointers stored in the priority data structure by passing data associated with the respective data transfers associated with the at least one of the pointers to a generative artificial intelligence model; and send the summary to the operating device.

In some implementations generating the summary further comprises prior to detecting the trigger condition, for one of the respective data transfers associated with the at least one of the pointers: generating a respective message specific to the one of the respective data transfers by passing data associated with the one of the respective data transfer to an error detecting artificial intelligence model; and storing, in a storage medium, the respective message in association with the one of the respective data transfers. Generating the summary may further comprise: retrieving, in response to detecting the trigger condition, from the storage medium, the respective message associated with the one of the respective data transfers; and including, in the data associated with the respective data transfers associated with the at least one of the pointers, the respective message.

In some implementations, the processor is further configured to train the error detecting artificial intelligence model using error training data, the error training data including a plurality of labelled pairs, at least one of the plurality of labelled pairs comprising: first sample data corresponding to a sample data transfer with an error; and second sample data corresponding to the sample data transfer with the error corrected.

In some implementations, the processor is further configured to train the error detecting artificial intelligence model using error training data, the error training data including a plurality of labelled pairs, at least one of the plurality of labelled pairs comprising: first sample data corresponding to a sample data transfer with an error; and second sample data corresponding to a description of the error.

In some implementations, the scoring artificial intelligence model is the error detecting artificial intelligence model.

In some implementations, the respective message indicates that the respective data transfer has an unidentifiable transferee.

In some implementations, the respective message indicates that a transferee address associated with the respective data transfer fails to map to a transferee identifier associated with the respective data transfer.

In another aspect, the present application discloses a computer-implemented method. The method comprises: receiving first data, the first data being associated with a first data transfer; generating a first score by passing at least a portion of the first data to a scoring artificial intelligence model, the first score indicating a first priority; associating the first data transfer with the first score; associating the first data transfer with a first pointer; inserting the first pointer into a priority data structure that stores a plurality of pointers associated with respective data transfers and respective scores, the respective scores indicating respective priorities, the first pointer being placed in the priority data structure based on the first score; detecting a distribution trigger condition associated with an operating device; removing, in response to detecting the distribution trigger condition, one pointer from the priority data structure, the respective score associated with the one pointer indicating a greater priority than the respective score associated with another pointer stored in the priority data structure; and sending data associated with the respective data transfer associated with the one pointer to the operating device.

In some implementations, the method further comprises training the scoring artificial intelligence model using training data, the training data including a plurality of labelled pairs, at least one of the plurality of labelled pairs comprising: sample data associated with a sample data transfer; and a sample score.

In some implementations, the method further comprises: generating, in association with the respective data transfer of the one pointer, a respective message specific to the respective data transfer by passing data associated with the respective data transfer to an error detecting artificial intelligence model; and storing, in a storage medium, the respective message in association with the respective data transfer.

In some implementations, sending data associated with the respective data transfer associated with the one pointer to the operating device further comprises: detecting that the one pointer has been removed from the priority data structure; retrieving the respective message associated with the one pointer from the storage medium; and sending the respective message to the operating device.

In some implementations, the method further comprises: detecting a trigger condition; generating, in response to detecting the trigger condition, a summary of the respective data transfers associated with at least one of the pointers stored in the priority data structure by passing data associated with the respective data transfers associated with the at least one of the pointers to a generative artificial intelligence model; and sending the summary to the operating device.

In some implementations, generating the summary further comprises, prior to detecting the trigger condition, for one of the respective data transfers associated with the at least one of the pointers: generating a respective message specific to the one of the respective data transfers by passing data associated with the one of the respective data transfers to an error detecting artificial intelligence model; and storing, in a storage medium, the respective message in association with the one of the respective data transfers. Generating the summary may further comprise: retrieving, in response to detecting the trigger condition, from the storage medium, the respective messages associated with the one of the respective transfers; and including, in the data associated with the respective data transfers associated with the at least one of the pointers, the respective message.

In another aspect, the present application discloses a computer-readable medium comprising instructions stored therein. When executed by a processor, the instructions cause a computer to: receive first data, the first data being associated with a first data transfer; generate a first score by passing at least a portion of the first data to a scoring artificial intelligence model, the first score indicating a first priority; associate the first data transfer with the first score; associate the first data transfer with a first pointer; insert the first pointer into a priority data structure that stores a plurality of pointers associated with respective data transfers and respective scores, the respective scores indicating respective priorities, the first pointer being placed in the priority data structure based on the first score; detect a distribution trigger condition associated with an operating device; remove, in response to detecting the distribution trigger condition, one pointer from the priority data structure, the respective score associated with the one pointer indicating a greater priority than the respective score associated with another pointer stored in the priority data structure; and send data associated with the respective data transfer associated with the one pointer to the operating device.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, the terms “transferor” and “transferee” may be used interchangeably with “sender” and “recipient”, respectively, in the context of describing transfers of resources. In some cases, the terms “payor” or “payee” may be used in the example of monetary resources.

The present subject matter uses trained ML models and/or GenAI to 1) rank or score data transfers or pending data transfers, 2) detect or identify defective, malicious, corrupted, illegitimate, or otherwise problematic data in data transfers or pending data transfers, 3) generate textual summaries for describing the problematic data. The ranking or scoring may be used to prioritize the review of certain data transfers. To this end, a priority-based queue, priority queue, or priority data structure may be used. The generated textual summaries may be presented on a display of a computer system or device associated with review of the data transfer.

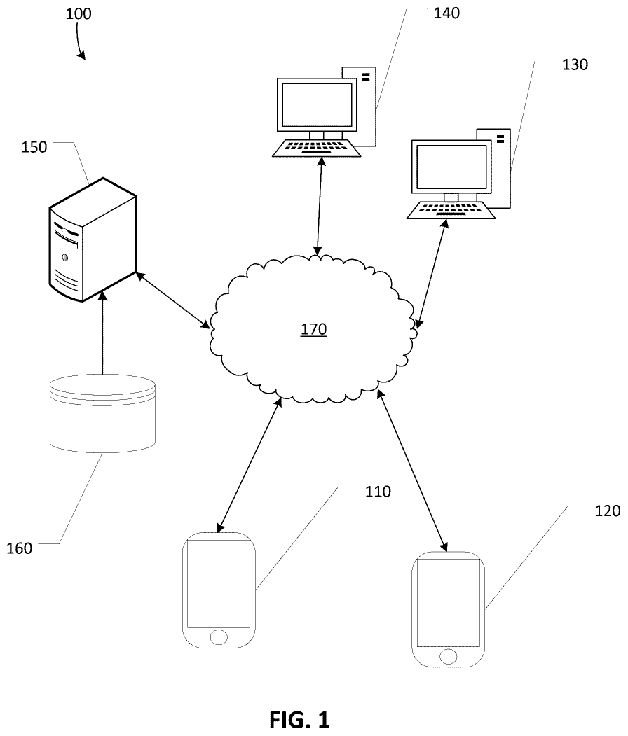

FIG. 1 is a schematic operation diagram illustrating an operating environment of an example embodiment of a data transfer review system 100. As shown, the data transfer review system 100 includes a client devices 110 and 120, operating devices 130 and 140, and a computer system 150 with a database 160. A network 170, which may include a public network such as the Internet and/or a private network, couples together the client devices 110 and 120, the operating devices 130 and 140, and the computer system 150. The client devices 110 and 120, the operating devices 130 and 140, and the computer system 150 may be in the same location or geographically disparate locations. In other words, the client devices 110 and 120, the operating devices 130 and 140, and the computer system 150 may be located remote from one another. While FIG. 1 depicts two client devices 110 and 120 and two operating devices 130 and 140, other embodiments may include more or less such devices.

The client devices 110 and 120 may be smartphones as shown in FIG. 1. However, the client devices 110 and 120 may be computing devices of another type such as for example a personal computer, a laptop, a tablet computer, a notebook computer, a hand-held computer, a personal digital assistance, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. Further, the client device 110 may be a different type of computing device than the client device 120. For example, the client device 110 may be a smartphone (as shown in FIG. 1) and the client device 120 may be a personal computer. The client devices 110 and 120 may be associated with an entity such as a client of a network security system. Additionally or alternatively, the client devices 110 and 120 may be associated with separate entities. For example the client device 110 may be associated with a first transferor of data and the client device 120 may be associated with a second transferor of data.

Similar to the client device 110 and 120, the operating devices 130 and 140, while shown to be personal computers in FIG. 1, may be computing devices of another type including any of the above examples of computing devices raised with respect to the client devices 110 and 120. The operating devices 130 and 140 may be associated with a users or operators such as data transfer review agents.

The computer system 150 may be, for example, a mainframe computer, a minicomputer, or the like. In some embodiments thereof, a computer system may be formed of or may include one or more computing devices. The computer system 150 may include and/or may communicate with multiple computing devices such as, for example, one or more database servers (including a database 160), computer servers, and the like. Multiple computing devices such as these may be in communication using a computer network and may communicate to act in cooperation as a computer server system. For example, the computing devices may communicate using a local-area network (LAN). In some embodiments, the computer system 150 may include multiple computing devices organized in a tiered arrangement. For example, the computer system 150 may include middle tier and back-end computing devices. In some embodiments, the computer system 150 may be a cluster formed of a plurality of interoperating computing devices.

In some embodiments, the computer system 150 may be associated with a network security system, a financial security system, a data security system, or another kind of security system of a company or institution. For example, the computer system 150 may be associated with a network security system protecting a company from cybercrime and, to that end, may maintain records of typical network activity or data transfers in the database 160. In another example, the computer system 150 may be associated with a financial security system of a financial institution and, to that end, may maintain records of customer financial accounts and associated financial data in the database 160. In yet another example, criteria for ranking or scoring a data transfer may be recorded in the database 160. The database 160 may be provided internally within the computer system 150 or externally. To that end, the database 160 may be stored in one or more data centers, and the data centers may store data with bank-grade security. Further, in some embodiments, the database 160, if external to the computer system 150, may be coupled to the computer system 150 via the network 170.

The network 170 is a computer network. In some embodiments, the network 170 may be an internetwork such as may be formed of one or more interconnected computer networks. For example, the network 170 may be or may include an Ethernet network, an asynchronous transfer mode (ATM) network, a wireless network, a telecommunications network, or the like.

In some embodiments, in operation, the computer system 150 and the operating devices 130 and 140 may collaborate to monitor network traffic or data transfers received by the client devices 110 and 120. In particular, the computer system 150 may rank or score the network traffic or data transfers and the operating devices 130 and 140 may review or monitor the network traffic or data transfers by order of the rank or score. For example, if the operating device 130 is tasked with reviewing a first data transfer having a score of, for example, 52 and reviewing a second data transfer having a score of, for example 13, the operating device 130 may review the first data transfer before the second data transfer (assuming that a higher or greater score indicates a higher or greater priority).

In other embodiments, in operation, the client devices 110 and 120 may initiate data transfers to other devices (not shown in FIG. 1) and the computer system 150 and the operating devices 130 and 140 may collaborate to monitor or review the data transfers. In particular, the computer system 150 may rank or score the network traffic or data transfers and the operating devices 130 and 140 may review or monitor the data transfers by order of rank or score. For example, if the operating device 130 is tasked with reviewing a first data transfer initiated by the client device 110 having a score of, for example, 52, and reviewing a second data transfer initiated by the client device 120 having a score of, for example, 61, the operating device 130 may review the second data transfer before the first data transfer (assuming that a higher or greater score indicates a higher or greater priority). In another operating example, if the operating device 130 is tasked with reviewing a first data transfer initiated by the client device 110 having a score of, for example 52, and reviewing a second data transfer also initiated by the client device 120 having a score of, for example 61, the operating device 130 may review the second data transfer before the first data transfer (assuming that a higher or greater score indicates a higher or greater priority).

The operating devices 130 and 140 may be assigned or tasked with reviewing the same or different data transfers. In some embodiments, the set of data transfers assigned to the operating device 130 and the set of data transfers assigned to the operating device 140 may be mutually exclusive. In other embodiment, the set of data transfers assigned to the operating device 130 and the set of data transfers assigned to the operating device 140 may have some overlap. For example, a low scoring data transfer may be reviewed by only one of the operating devices 130 and 140 whereas a high scoring data transfer may be reviewed by both of the operating devices 130 and 140.

In some embodiment, in operation, the computer system 150 may delegate or assign monitoring or review of data transfers to the operating devices 130 and 140. Further the computer system 150 may maintain a priority data structure such as a priority queue based on scoring of data transfers. In some embodiments, the computer system 150 may maintain priority data structures specific to the operating devices 130 and 140. For example, the computer system 150 may maintain a first priority queue of data transfers in association with the operating device 130 and a second priority queue of data transfers in association with the operating devices 140. In this example, the operating device 130 may only monitor or review data transfers from the first priority queue and the operating device 140 may only monitor or review data transfers from the second priority queue. In other embodiments, the computer system 150 may maintain a shared or common priority data structure for the operating devices 130 and 140. For example, in operation, the computer system 150 may monitor the amount of data transfers that have been assigned for review to each of the operating devices 130 and 140. In this example, when the number of data transfer assigned to, for example, the operating device 130 is below a particular threshold, the computer system 150 may assign one or more data transfers represented in the shared priority data structure to the operating device 130. The shared priority data structure may be configured such that data transfers with a higher score are removed or popped from the shared priority data structure before data transfers with a lower score.

FIG. 1 illustrates an example representation of components of the data transfer review system 100. The data transfer review system 100 can, however, be implemented differently than the example of FIG. 1. For example, various components that are illustrated as separate systems in FIG. 1 may be implemented on a common system. By way of further example, the functions of a single component may be divided into multiple components. In another embodiment, the data transfer review system 100 may be a cloud-based system. For example, the computer system 150 may itself be virtual and the various components and modules thereof may be resident on the cloud. The computer system 150 may include one or more virtual machines or virtual processors that may be accessed via the cloud.

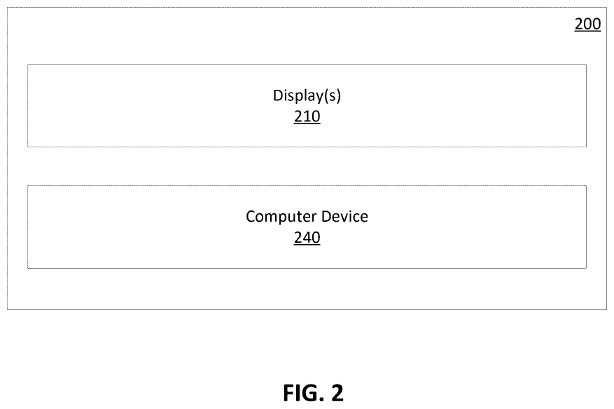

FIG. 2 is a simplified schematic diagram showing components of an exemplary computing device 200, such as the client devices 110 and 120 or the operating devices 130 and 140 (see FIG. 1). The exemplary computing device 200 may include modules including, as illustrated, for example, one or more displays 210 and a computer device 240.

The one or more displays 210 are a display module. The one or more displays 210 are used to display screens of a graphical user interface that may be used, for example, to communicate with the computer system 150 (see FIG. 1). The one or more displays 210 may be internal displays of the exemplary computing device 200 (e.g., disposed within a body of the computing device).

The computer device 240 is in communication with the one or more displays 210. The computer device 240 may be or may include a processor which is coupled to the one or more displays 210.

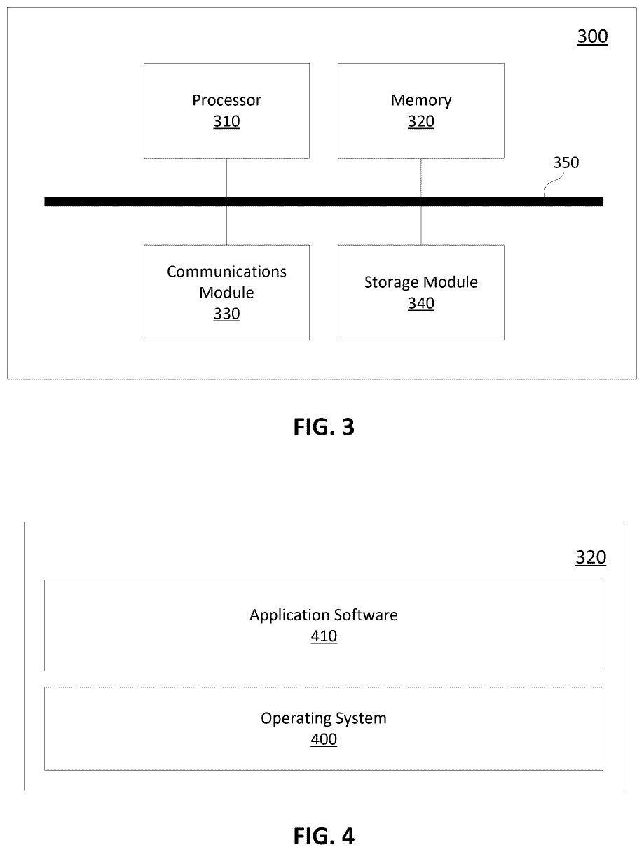

Referring now to FIG. 3, a high-level operation diagram of an example computer system 300 is shown. In some embodiments, the example computing system 300 may be exemplary of the computer system 150, the client devices 110 and 120, and/or the operating devices 130 and 140 (see FIG. 1). The example computer system 300 includes a variety of modules. For example, the example computer system 300 may include at least one processor 310, a memory 320, a communications module 330, and/or a storage module 340. As illustrated, the foregoing example modules of the example computer system 300 are in communication over a bus 350.

The at least one processor 310 is a hardware processor. The at least one processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive, or the like. Read-only memory and persistent storage are non-transitory computer-readable storage mediums. A computer-readable medium may be organized using a file system such as may be administered by an operating system governing overall operation of the example computer system 300.

The communications module 330 allows the example computer system 300 to communicate with other computer or computing devices and/or various communications networks. For example, the communications module 330 may allow the example computer system 300 to send or receive communications signals to/from the client devices 110 and 120 or the operating devices 130 and 140 over the network 170 (see FIG. 1). Communications signals may be sent or received according to one or more protocols or according to one or more standards. For example, the communications module 330 may allow the example computing system 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computing system 300 to communicate using near-field communication (NFC), via Wi-Fi™, using Bluetooth™ or via some combination of one or more networks or protocols. In some embodiments, all or a portion of the communications module 330 may be integrated into a component of the example computing system 300. For example, the communications module 330 may be integrated into a communications chipset. In some embodiments, the communications module 330 may be omitted such as, for example, if sending and receiving communications is not required in a particular application.

The storage module 340 allows the example computing system 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as the database 160, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the at least one processor 310 in concert with the communications module 330 such as, for example, if data is stored remotely. The storage module may also be referred to as a data store.

Software comprising instructions is executed by the at least one processor 310 from a computer-readable medium. For example, software may be loaded into random-access memory from persistent storage of the memory 320. Additionally or alternatively, instructions may be executed by the at least one processor 310 directly from read-only memory of the memory 320.

FIG. 4 depicts a simplified organization of software components stored in the memory 320 of the example computing system 300 (see FIG. 3). As illustrated, these software components include an operating system 400 and application software 410.

The operating system 400 is software. The operating system 400 allows the application software 410 to access the at least one processor 310, the memory 320, and the communications module 330 of the example computing system 300 (see FIG. 3). The operating system 400 may be, for example, Google™ Android™, Apple™ iOS™, UNIX™, Linux™, Microsoft™ Windows™, Apple OSX™ or the like.

The application software 410 adapts the example computing system 300, in combination with the operating system 400, to operate as a device performing a particular function. For example, the application software 410 may cooperate with the operating system 400 to adapt a suitable embodiment of the example computing system 300 to operate as the computing system 150, the client devices 110 and 120, and/or the operating devices 130 and 140 (see FIG. 1).

While the application software 410 appears singular in FIG. 4, in operation, the memory 320 may include more than one application software 410 for different applications that may perform different operations. For example, in at least some embodiments in which the example computing system 300 is functioning as the operating device 130, the application software 410 may include software for an application for displaying a graphical user interface associated with sending an application programming interface request. The computer system 150 may be configured to receive application programming interface requests and may perform operations to respond thereto.

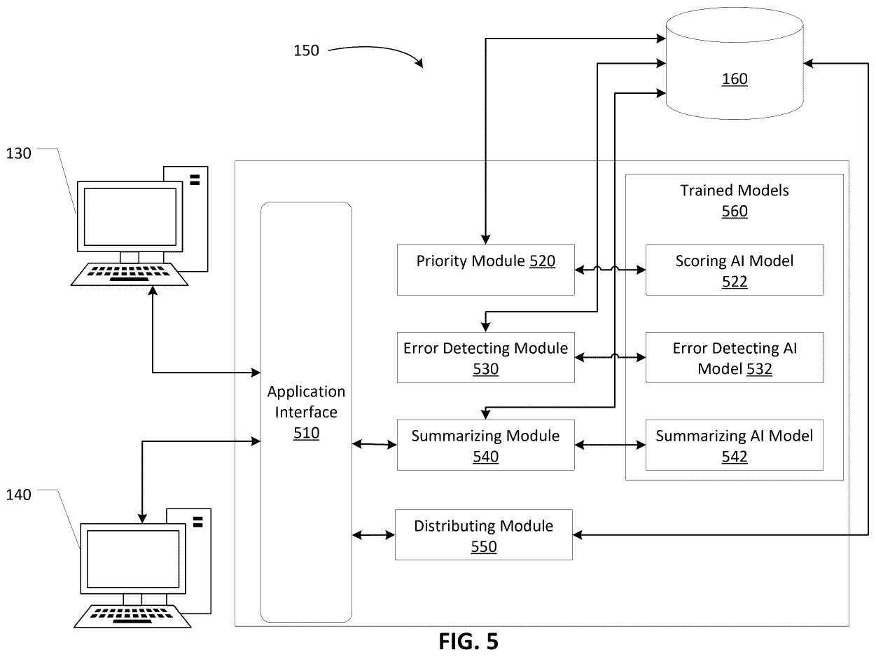

FIG. 5 is a simplified schematic diagram showing components of the computer system 150 in greater detail and the database 160 (see FIG. 1). The computer system 150 may store computer-executable instructions in the memory 320, which may be executed by a processing unit such as the processor 310, to implement one or more embodiments disclosed herein (see FIG. 3). The depicted example embodiments are directed to the computer system 150 that uses trained ML models, including GenAI, to enhance data transfer security. The computer system 150 may receive a request from a user device such as the operating devices 130 and 140 (see FIG. 1). The computer system 150 may then prompt or cause one or more trained ML models, including a GenAI models, to provide or generate output based on the input. The computer system may send the output from the one or more trained ML models to the user device. Additionally or alternatively, the computer system 150 may receive data related to a data transfer initiated by a client device such as the client devices 110 and 120, and cause one or more trained ML models to rank or score the initiated data transfer based on the related data (see FIG. 1).

The memory 320 of the computer system 150 may store instructions for implementing software applications including an application interface 510,, a priority module 520, an error detecting module 530, a summarizing module 540, and a distributing module 550, and trained models 560.

In some embodiments, some of the software applications may be hosted on a host platform. The host platform may be a cloud platform, web server, etc., that hosts software applications and other software programs that are hosted and made available on the Internet to the operating devices 130 and 140. In other examples, the priority module 520 may reside in the memory 320 of the operating devices 130 and 140 while, the error detecting module 530, the summarizing module 540, the distributing module 550, and the trained models 560 reside in the memory 320 of the computer system 150. Other variations are possible.

In any case, the application interface 510 may act as a software intermediary that allows an application executing on the operating devices 130 and 140 to communicate with an application executing on the computer system 150. The application interface 510 may allow the operating devices 130 and 140 to request distribution of one or more data transfers for review. The application interface 510 may also allow the operating devices 130 and 140 to request summaries for one or more data transfers assigned for review. A data transfer may be considered assigned to an operating device if, in the normal course of operation, the operating device will eventually monitor or review the data transfer. For example, data relating to a data transfer to be reviewed by the operating device 130 may not reside on the operation device 130. That is, the computer system may not have sent, transmitted, or distributed the data relating to the data transfer to the operating device yet. This type of data transfer may be considered assigned to the operating device 130 but not distributed to the operating device 130.

The application interface 510 may be configured to receive application programming interface (API) requests that define parameters. The application interface 510 may perform operations to obtain data to fulfill API requests.

In some embodiments, the application interface 510 may include a representational state transfer (REST) API. The REST API may utilize Hypertext Transfer Protocol (HTTP) methods (e.g. GET, POST) to receive and respond to API requests. The REST API may obtain data according to API requests and may return fixed data sets as a response to the API requests.

In some embodiments, the application interface 510 may include a GraphQL API. The GraphQL API may be hierarchical. The GraphQL API may obtain data according to API requests without under fetching or over fetching data.

The application interface 510 may include both the REST API and the GraphQL schemas and may perform operations to select one of the REST and GraphQL APIs. In one or more embodiments, the computer system 150 may receive an API request in a format compliant with one of the API schemas and may translate the request into another format.

The priority module 520 may comprise instructions to the processor 310 to maintain one or more priority data structures temporarily storing data transfers or data associated with data transfers. The priority data structure may also organize the temporarily stored data transfers based on a rank or score associated with the temporarily stored data transfers. The rank or score may reflect, indicate, or represent a priority of a data transfer. That is, the rank or score may measure, without limitation, a defectiveness, maliciousness, legitimateness, corruptness, validity, integrity, or accuracy of the data transfer or data associated with the data transfer. In some embodiments, the rank or score may be an integer between 1 and 100. In other embodiments, the rank or score may be a real number between 0 and 1. In other embodiments, the rank or score may be a status such as “low,” “medium,” and “high.” In the case of a numerical rank or score such as between 0 and 100, in some embodiments, a lesser number may reflect or indicate a greater priority. In other embodiments with numerical ranks or scores, a greater number may reflect or indicate a greater priority.

In some embodiments, the priority data structure maintained by the priority module 520 may store markers or pointers that map to or point to data associated with data transfers or the data transfers themselves. For example, the computer system 150 may receive data associated with a data transfer initiated by the client device 120 and generate a pointer for the data transfer to store in the priority data structure. The data associated with the initiated data transfer or the initiated data transfer itself may be stored in a database such as the database 160. That is, the generated pointer stored in the priority data structure may point to an entry or data in the database 160.

In some embodiments, the computer system 150 may maintain a priority data structure for each operating device. For example, the operating devices 130 and 140 may each have a corresponding priority data structure maintained by the computer system 150 wherein the corresponding priority data structures store markers or pointers pointing to data associated with the data transfers assigned to the operating devices 130 and 140. That is, the markers or pointers in the priority data structure maintained for the operating device 130 points or refers to data associated with data transfers assigned to the operating device 130, and likewise for the operating device 140. Further, the data transfers associated with the markers or pointers in the priority data structure maintained for the operating device 130 may be considered assigned to the operating device 130. Likewise, the data transfers associated with the markers or pointers in the priority data structure maintained for the operating device 140 may be considered assigned to the operating device 140. In some embodiments, the priority module 520 or another module (shown or not shown in FIG. 5) may comprise instructions to the processor 310 for assigning data transfers to the operating devices 130 and 140.

In other embodiments, the computer system 150 may maintain a singular priority data structure for both of the operating devices 130 and 140. In this embodiment, a data transfer may not be assigned for monitoring or review to either of the operating devices 130 and 140 while its associated pointer is stored in the singular priority data structure.

In some embodiments, some of the data transfers may be time-sensitive. For example, there may exist a protocol, guideline, or rule against the monitoring or review of a data transfer after a period of time has elapsed after the data transfer has been initiated. In this example, markers or pointers pointing to data associated with data transfers for which this period of time has elapsed may be removed from the priority data structure maintained by the computer system 150. In this example, the computer system 150 may periodically examine or check the priority data structure for these “elapsed” or “expired” data transfers. Additionally or alternatively, the computer system 150 may not remove these “elapsed” or “expired” data transfers and merely not send or distribute associated data to an operating device such as the operating device 130 or 140 when the corresponding pointers are removed or popped from the priority data structure.

The priority module 520 may further comprise instructions to the processor 310 to rank or score a data transfer. The computer system 150 may rank or score the data transfer by making a call to or prompting a scoring AI model 522. The scoring AI model 522 may be a ML model that has been trained to score a data transfer based on data associated with the data transfer. The data associated with the data transfer that the scoring AI model 522 may use to score the data transfer includes without limitation the data being transferred, a resource or resource amount associated with the data transfer, a time or a plurality of times associated with the data transfer, a time period associated with the data transfer, a deadline associated with the data transfer, a source, sender, transferor, or transmitter of the data transfer, a destination, recipient, or transferee, or receiver of the data transfer, an address associated with the data transfer, a virtual address associated with the data transfer, a data transfer history associated with the transferor, a data transfer history associated with the transferee, and text or messaging associated with the data transfer. The scoring AI model 522 may be, for example, a trained neural network, a trained deep neural network (DNN), or a trained convolutional neural network (CNN). The scoring AI model 522 may be stored in the memory 320 of the computer system 150 as one of the trained models 560, or may be stored and accessed remotely (not shown).

While the scoring AI model 522 may be specifically trained to rank or score data transfers, in other embodiments, the functions of the scoring AI model 522 may be performed by a foundational model such as a refined or trained GenAI model. In such an embodiment, the priority module 520 may also further comprise instructions to the processor 310 for constructing a prompt to the GenAI model that would cause or likely cause the GenAI model to provide the desire output and/or provide output in a desired format.

In some embodiments, the data transfers may be time-sensitive in that the rank or score of some data transfers may change according to the time. In such embodiments, the computer system 150 may be configured to have the scoring AI model 522 periodically reevaluate the data transfers represented by the markers or pointers in the priority data structure. The computer system 150 may subsequently rearrange the organization of the markers or pointers in the priority data structure. Additionally or alternatively, the computer system 150 may reevaluate the data transfers represented by the markers or pointers in the priority data structure upon detecting a trigger condition. The trigger condition may be, for example, an elapse of a predefined amount of time or a request received from one of the operating devices 130 and 140.

In some embodiments, the priority data structure may also store the ranks, scores, or priorities of the data transfers associated with the markers or pointers stored therein. For example, the priority data structure may be implemented as a tree with nodes. In this example implementation, each node may comprise 1) a variable for the marker or pointer mapping or referring to the associated data transfers, and 2) another variable for the rank, score, or priority of the associated data transfer.

While FIG. 5 depicts the priority module 520 prompting or calling the scoring AI model 522, other variations are possible. For example, in an embodiment where the priority module resides on the operating device 130, the distributing module 550 may prompt or call the scoring AI model 522 to rank or score a data transfer before assigning or distributing the data transfer to the operating device 130. In this embodiment, pointers in the priority data structure stored on the operating device 130 may be processed via the application interface 510. That is, data associated with the data transfer stored in the database 160 may be sent to the operating device 130 through the computer system 150 after processing the pointers. That is, in this embodiment, the data associated with the data transfer may not be sent directly to the operating device 130 from the database 160.

The error detecting module 530 may comprise instructions to the processor 310 to detect potential errors, defective data or otherwise problematic data with respect to a data transfer. To this end, the computer system 150 may prompt or use an error detecting AI model 532 to identify the errors or problematic data. The error detecting AI model 532 may be a ML model that has been trained to detect errors or problematic data in a data transfer based on data associated with the data transfer.

The data associated with the data transfer that the error detecting AI model 532 may use to detect errors or problematic data includes without limitation the data being transferred, a resource or resource amount associated with the data transfer, a time or a plurality of times associated with the data transfer, a time period associated with the data transfer, a deadline associated with the data transfer, a source, sender, transferor, or transmitter of the data transfer, a destination, recipient, or transferee, or receiver of the data transfer, an address associated with the data transfer, a virtual address associated with the data transfer, a data transfer history associated with the transferor, a data transfer history associated with the transferee, and text or messaging associated with the data transfer. In some embodiments, the error detecting module 530 may cause the computer system 150 retrieve or extract at least a portion of a data transfer history associated with the transferor or transferee of a data transfer from the database 160 and prompt the error detecting AI model 532 with the portion of the data transfer history. In some embodiments, data used as input or prompting material for the error detecting AI model 532 may be the same, or largely the same, as the data used as input or prompting material for the scoring AI model 522.

Possible errors, defective data, or otherwise problematic data that the error detecting AI model 532 can detect include without limitation unidentified, unidentifiable, or non-existent transferees or transferors, a transferee or transferor that is a known bad actor, a data transfer that diverges from, conflicts with, or contradicts a data transfer history associated with the transferee or transferor, an unsupported data transfer, a data transfer corresponding to a transfer of an amount of a resource that the transferor does not possess, and text or messaging associated with the data transfer that is threatening, indicative of crime or fraud, or harmful. Further, in some embodiments, authorized or verified transferees and transferors may have respective identifiers that are stored in association with addresses or transfer addresses in the database 160. That is, the addresses and the identifiers may map to each other have form a mapping. In these embodiments, a possible error with respect to a data transfer is that a mapping or matching between a transferee identifier and a transferee address associated with the data transfer cannot be found in the database 160 or another storage medium. In response to receiving a prompt or input to detect errors or problematic data, the error detecting AI model 532 may output text describing a detected errors or problematic data. For example, the error detecting AI model 532 may output the message:
“Data transfer [id] is a data transfer with an unidentifiable transferee.”

In the above example output, [id] may be a data transfer identifier. The data transfer may have been generated upon initiation of the data transfer. For example, in the event that the client device 110 initiated a data transfer, the computer system 150 may have generated a data transfer identifier for that data transfer. The data transfer identifier may be considered data associated with the data transfer.

In some embodiments, the error detecting module 530 may further comprise instructions to the processor 310 to store the output of the error detecting AI model 532 with respect to a data transfer in association with the data transfer. This output may be stored, for example, in the database 160. Further, in some embodiments, when one of the operating devices 130 and 140 is monitoring or reviewing the data transfer, the computer system 150 may retrieve or extract the stored output associated with the data transfer from the database 160 and send, transmit or distribute that output to the operating device. In some embodiments where the stored output is a text message, the text message may be presented on a display of the operating device.

The error detecting AI model 532 may be, for example, a trained neural network, a trained DNN, a trained CNN, an LLM, or a GenAI model. The error detecting AI model 532 may be stored in the memory 320 of the computer system 150 the trained models 560, or may be stored and accessed remotely (not shown).

While the error detecting AI model 532 may be specifically trained to detect errors or problematic data with respect to data transfers, in other embodiments, the functions of the error detecting AI model 532 may be performed by a foundational model such as a refined or trained GenAI model. In such an embodiment, the error detecting module 530 may also further comprise instructions to the processor 310 for constructing or generating a prompt to the foundational model that would cause or likely cause the foundational model to provide the desire output and/or provide output in a desired format.

The summarizing module 540 may comprise instructions to the processor 310 to summarize or textually summarize one or more of the data transfers assigned to an operating device such as the operating device 130 or 140. To this end, the summarizing module 540 may instruct the processor 310 to call or use a summarizing AI model 542 to generate a summary. The summarizing AI model 542 may be a GenAI model and large language model (LLM) capable of receiving prompts or inputs and generating textual responses or outputs to the prompts or inputs. In some embodiments, the prompts or inputs may be natural language inputs that include instructions to the summarizing AI model 542 to generate desired responses or outputs. In some embodiments, the summarizing AI model 542 may be stored within a model repository as one of the trained models 560. In other embodiments, the summarizing AI model 542 may be stored and accessed remotely from a cloud.

According to various embodiments, the summarizing AI model 542 may be a LLM, such as a multimodal LLM. As another example, the summarizing AI model 542 may be a transformer neural network (“transformer”) or the like. A language model may use a neural network (typically a DNN) to perform natural language processing (NLP) tasks such as language translation, image captioning, grammatical error correction and natural language generation, among others. A language model may be trained to learn parameters in order to model how words relate to each other in a textual sequence, based on probabilities. A language model may contain hundreds of thousands of learned parameters or in the case of a LLM may contain millions or billions of learned parameters or more. In that manner, the summarizing AI model 542 can learn the patterns and structure of their input training data and then generate new content that has similar characteristics.

In some embodiments, a prompt or input to the summarizing AI model 542 for generating a summary or textual summary may include without limitation, data associated with at least one data transfer, potential errors, defective data, malicious data, illegitimate data, corrupted data, or otherwise problematic data that has already been identified by the computer system 150, textual messages identifying potential errors, defective data, or otherwise problematic data that has already been identified with respect to one or more data transfers, and textual instructions. In some embodiments, the textual instructions may be generated or constructed by prompt engineering software or programming. An example output of the summarizing AI model 542 may be:
“8 data transfers pending review. 2 appear to have unidentified transferees. 2 appear to diverge from a known data transfer history of the transferor. 1 appears to have a transferee known to be a bad actor.”

The distributing module 550 may comprise instructions to the processor 310 to send, transmit, or distribute data related to a data transfer to at least one of the operating devices 130 and 140. Upon receiving the data, the operating device may monitor or review the data transfer. In some embodiments, one of the operating devices 130 and 140 may request, via the application interface 510, distribution of one or more data transfers. In response, the computer system 150 may send, transmit, or distribute, data associated with one or more data transfers to the operating device according to the instructions in the distributing module 550. In other embodiments, the distributing module 550 may allow the computer system 150 to monitor the workload or amount of data transfers distributed for monitoring or review to the operating devices 130 and 140. For example, the operating devices 130 and 140 may periodically post their workloads, say every 15 minutes, to the computer system 150 via the application interface 510. The distributing module 550 may allow the computer system 150 to determine that one of the operating devices 130 and 140 has a low workload, or workload below a threshold, and in response, distribute data associated with one or more data transfers to that one of the operating devices 130 and 140. In some embodiments, the distributing module 550 may cooperate with the priority module 520 to configure the computer system 150 to assign to the operating devices 130 and 140 higher or greater priority data transfers before lower or lesser priority data transfers. Further, upon sending or distributing data associated with one or more data transfers, the distributing module 550 may transmit or send a message to the operating device that received the data. For example, upon sending data associated with a first data transfer to the operating device 130, the computer system 150 may send the message “A new data transfer has been sent for review” to the operating device 130. In this example, the message may be presented on a display of the operating device 130.

The priority module 520, the error detecting module 530, the summarizing module 540, and the distributing module 550 may collaborate together to enhance data transfer security. For example, in operation, upon a client device such as the client device 110 initiating or receiving a data transfer, the computer system may assign the data transfer to, for example, the operating device 130. The computer system 150 may then, according to the priority module 520, generate a score indicating a priority for the data transfer using the scoring AI model 522. The computer system 150 may then, according to the error detecting module 530, generate a message or error message via the error detecting AI model 532 and store that message or error message in association with the data transfer in the database 160. The computer system may then, according to the priority module 520, place a marker or pointer associated with the data transfer in a priority data structure associated with the operating device 130.

Later on, the computer system 150 may receive a request for a summary from, for example, the operating device 130 via the application interface 510. The computer system 150 may then identify one or more data transfers assigned to the operating device and stored in the priority data structure associated with the operating device 130. The identified one or more data transfers may be the data transfers in the priority data structure that have the greatest priority, rank, or score. The error detecting AI model 532 may have already detected errors with respect to the identified one or more data transfers. Further, the database 160 may already have stored messages or error messages, generated by the error detecting AI model 532, that correspond to the identified one or more data transfers. The summarizing module 540 may then cause the computer system 150 to retrieve, from the database 160, data associated with the identified one or more data transfers including corresponding messages or error messages. The summarizing module 540 may then cause the computer system 150 to prompt the summarizing AI model 542 to generate a textual summary based, at least partially, on the data retrieved from the database 160. The computer system 150 may then send, transmit, distribute, or return the generated textual summary to the operating device.

Further, while FIG. 5 depicts the scoring AI model 522, the error detecting AI model 532, and the summarizing AI model 542 as separate ML and GenAI models, other embodiments where a trained model performs the functions of one or more of the described models may exist. For example, the functions of the scoring AI model 522 and the error detecting AI model 532 may be performed by the same ML or GenAI model. In another example, the functions of the summarizing AI model 542 and the error detecting AI model 532 may be performed by the same GenAI model or LLM. In yet another example, a foundational model such as a GenAI model or LLM may perform the functions of all three of the scoring AI model 522, the error detecting AI model 532, and the summarizing AI model 542.

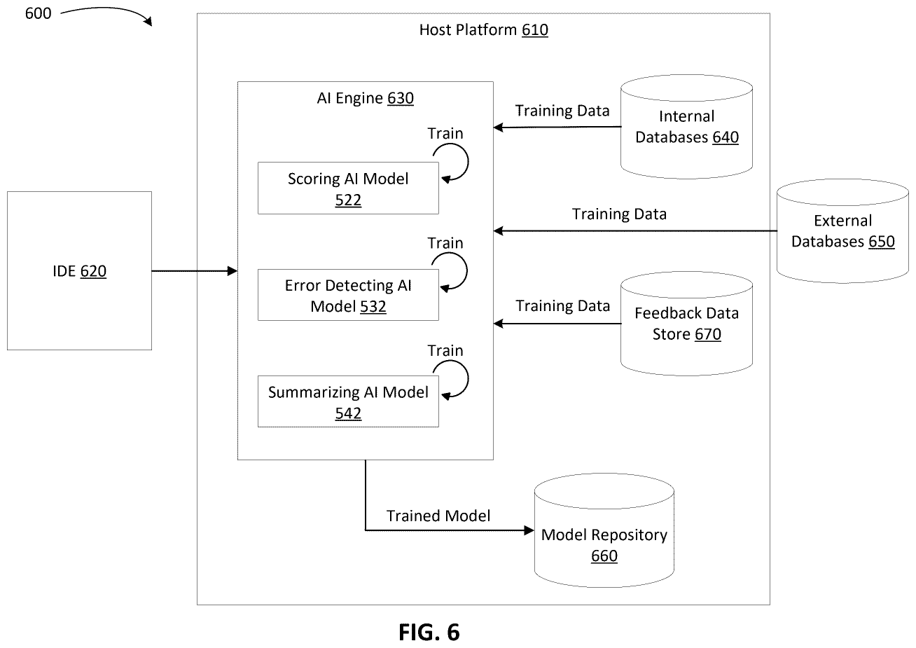

Reference is now made to FIG. 6 which schematically illustrates a process 600 of training the parameters of the trained models 560 according to example embodiments (see FIG. 5). Referring to FIG. 6, a host platform 610 may host an IDE 620 (integrated development environment) where GenAI models, machine learning models, AI models, and the like may be developed, trained, retrained, and the like. In this example, the IDE 620 may include a software application with a user interface accessible by a user device over a network or through a local connection.

For example, the IDE 620 may be embodied as a web application that can be accessed at a network address, URL, etc., by a device. As another example, the IDE 620 may be locally or remotely installed on a computing device used by a user.

The IDE 620 may be used to design a model (via a user interface of the IDE), such as a ML model that can rank or score data transfers, a ML model that can detect errors or problematic data of data transfers, and a GenAI model that can summarize a plurality of data transfers. The model can then be executed/trained based on training data established via the user interface. During training, the scoring AI model 522, the error detecting AI model 532, and the summarizing AI model 542 may be executed on training data via an AI engine 630 of the host platform 610.

A GenAI model such as the summarizing AI model 542 may be trained to understand and generate text based on a large corpus of documentation. The training data may be provided from a training data store such as an internal database 640, which may include training samples from the web, from customers, and the like. Additionally or alternatively, the training data may be pulled from one or more external databases 650 such as publicly available sites, etc.

In some embodiments, the payload of data may be in a format that is not capable of being input to a ML or GenAI model such as the scoring AI model 522, the error detecting AI model 532, or the summarizing AI model 542. Further a computer processor may be unable to read the payload data. For example, the payload of data may be in text format, image format, audio format, and the like. In response, the AI engine 630 may convert the payload of data into a format that is readable by the ML or GenAI model, such as a vector or other encoding. The vector may then be input to the ML or GenAI model.

The AI engine 630 may iteratively retrieve additional training data sets from the internal and external databases 640, 650 and iteratively input the additional training data sets into a ML or GenAI model during the execution of the model to continue to train the model. The AI engine 630 may continue the process until it receives instructions to terminate, which may be based on a number of iterations (training loops), total time elapsed during the training process, etc.

When a ML or GenAI model is sufficiently trained, it may be stored within a model repository 660 as one of the trained models 560 via the IDE 620 or the like (see FIG. 5).

The IDE 620 may also be used to retrain a ML or GenAI after the model has been deployed. Here, the training process may use executional results that have already been generated or output by the ML or GenAI model in a live environment to retrain the ML or GenAI model. For example, scores output by the scoring AI model 522 and feedback with respect to those scores may be used to retrain the scoring AI model 522 model to further enhance its accuracy. The feedback may include indications of whether the generated output scores match scores resulting from a manual evaluation of an agent and what the manual evaluation of the agent is. In another example, the error messages output by the error detecting AI model 532 and feedback with respect to those error messages may be used to retain the error detecting AI model 532 to further enhance the accuracy or appropriateness of the error messages. The feedback may include indications of whether the outputted error message adequately describes the detected error (if there is one) and what the appropriate error message would be according to an agent. In yet another example, textual summaries generated by the summarizing AI model 542 and feedback with respect to those textual summaries may be used to retrain the summarizing AI model 542 to further enhance its accuracy or reliability. The feedback may include indications of whether the generated textual summaries adequately summarize data transfers according to an agent and what an appropriate summary would be according to the agent. The described feedback data may be captured and stored within a feedback data store 670 or other data store within the live environment and can be subsequently used to retrain the scoring AI model 522, the summarizing AI model 542, and the error detecting AI model 532.

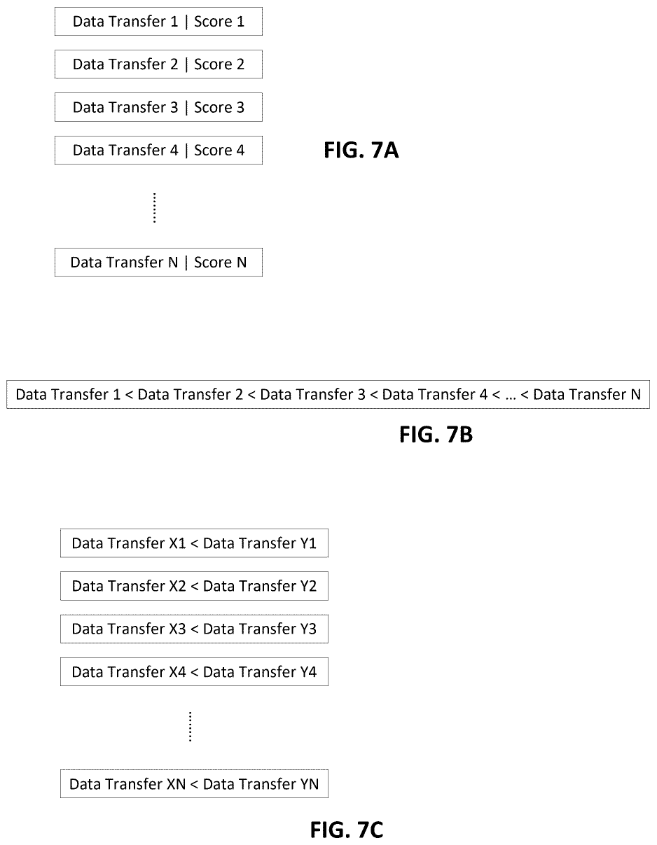

Reference is now made to FIGS. 7A-7C which illustrate, without limitation, representations of training data that could be used to train the scoring AI model 522 (see FIG. 5). FIG. 7A depicts a plurality of labelled pairs (or N labelled pairs) wherein each of the plurality of labelled pairs comprises sample data associated with a sample data transfer (denoted as Data Transfer [number] in FIG. 7A) and a sample score (denoted as Score [number] in FIG. 7A). In some implementations, the sample scores may be assigned or tagged to the sample data manually.

FIG. 7B depicts training data that is a list of units of sample data. Each unit of sample data may be associated with a sample data transfer having an associated rank, score, or priority. The list may be sorted according to the associated rank, score, or priority. Many such lists (perhaps at least 1000) may be used to train the scoring AI model 522. In some implementations, the list may be constructed manually.

FIG. 7C depicts training that is a plurality of labelled pairs (or N labelled pairs), each of the plurality of labelled pairs comprising 1) first sample data associated with a first sample data transfers (denoted by Data Transfer X[number]) and 2) second sample data associated with a second sample data transfer (denoted by Data Transfer Y[number]). The second sample data transfer has a greater rank, score, or priority than the first sample data transfer. In some implementations, these labelled pairs may be prepared manually.

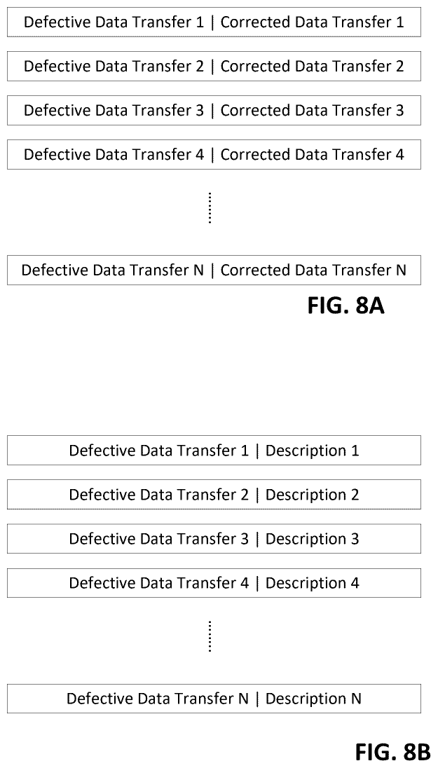

Reference is now made to FIGS. 8A and 8B which illustrate, without limitation, representations of error training data that could be used to train the error detecting AI model 532. FIG. 8A depicts a plurality of labelled pairs (or N labelled pairs). Each of the labelled pairs comprise 1) first sample data corresponding to a sample data transfer with an error (denoted by Defective Data Transfer [number]) and 2) second sample data corresponding to the sample data transfer with the error corrected (denoted by Corrected Data Transfer [number]). In some implementations, the plurality of pairs may be prepared manually.

FIG. 8B depicts a plurality of pairs (or N labelled pairs). Each of the labelled pairs comprise 1) first sample data corresponding to a sample data transfer with an error (denoted by Defective Data Transfer [number]) and 2) second sample data corresponding to a description of the error (denoted by Description [number]). In some implementations, the plurality of pairs and the description may be prepared manually.

Further, while not shown or represented in a figure, the error detecting AI model 532 may also be trained using data related to bad actors. Bad actors may be, for example, known criminals, terrorists, cybercriminals, frauds, etc. Data related to bad actors may be, for example, addresses, virtual addresses, IP addresses, geographical locations, telephone numbers, etc.

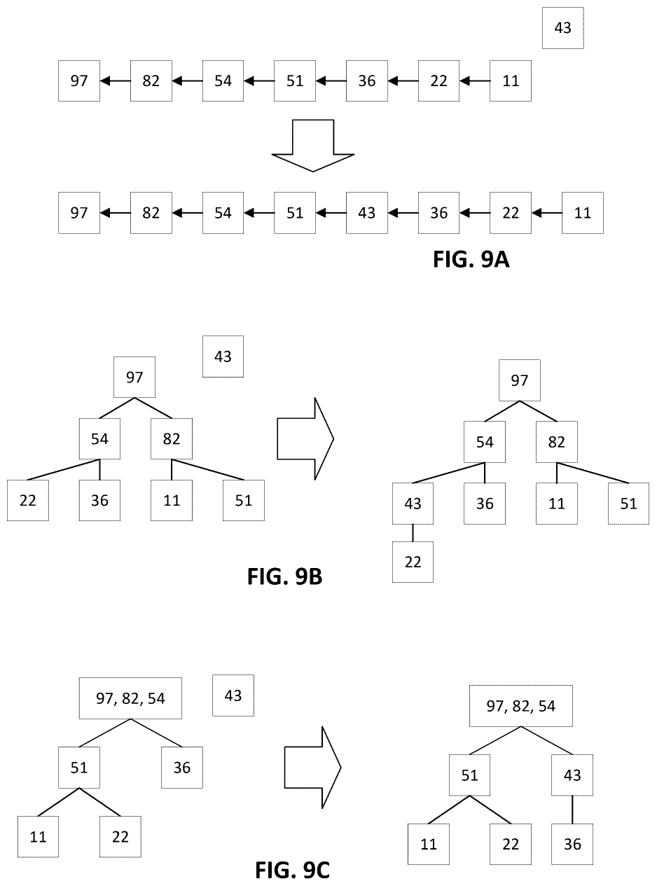

Reference is now made to FIGS. 9A-9C which abstractly illustrate, without limitation, implementations of a priority data structure maintained by the computer system 150 according to instructions from the priority module 520 (see FIG. 5). For simplicity, FIGS. 9A-9C represent a marker or pointer stored in the priority data structure as a square node and the numbers depicted on the square nodes indicate a rank, score, or priority for the associated data transfer. Further, in FIGS. 9A-9C, a greater number or score indicates a greater priority.

FIG. 9A depicts a simple sorted queue for the priority data structure. The front or head of the simple sorted queue is the pointer associated with the data transfers with the greatest rank, score, or priority. Further, the simple sorted queue is sorted. Thus, the pointer after the head has the next greatest priority, the one after that has the next greatest priority, and so on. When a pointer is removed from the simple sorted queue as part of assigning the associated data transfer an operating device such as the operating device 130 or 140 (see FIG. 1), the head pointer may be removed and the following pointer may become the new head of the simple sorted queue.

FIG. 9A further depicts the operation of inserting a new pointer associated with a new data transfer to the simple sorted queue or priority data structure. The new pointer is inserted into the simple sorted queue such that the sorted nature of the simple sorted queue remains intact.

FIG. 9B depicts a maximum heap implementation of the priority data structure. The root node or pointer of the maximum heap is the pointer associated with the data transfer with the greatest priority. Each node or pointer may have up to two child notes or pointers. A node or pointer is necessarily associated with a data transfer of greater priority than any of its child nodes. Further, the maximum heap in FIG. 9B is implemented as a binary heap. When a pointer is removed from the maximum heap as part of assigning the associated data transfer to an operating device such as the operation device 130 or 140, the root pointer may be removed. Subsequently, a standard sink operation may be performed to maintain the maximum heap structure.

FIG. 9B further depicts the operation of inserting a new pointer associated with a new data transfer to the maximum heap or priority data structure. The new pointer is inserted into the maximum heap using a standard swim operation. The swim operation may maintain the maximum heap structure.

FIG. 9C depicts a variation of the maximum heap implementation of the priority data structure. The implementation depicted in FIG. 9C differs from FIG. 9B in that the root node of the maximum heap in FIG. 9C contains, stores, or represents three pointers. The three pointers are the pointers associated with the data transfers with the three greatest scores or priorities. Otherwise, the maximum heap in FIG. 9C may be implemented similarly to the maximum heap in FIG. 9B and be implemented with a usual maximum heap structure and standard sink and swim operations for removing and inserting pointers into the priority data structure. A benefit of the implementation in FIG. 9C (or benefit of having more than one pointer in the root) is that, through the use of a peek operation that retrieves data in the root without removing the data from the priority data structure, the computer system 150 may be able to summarize a plurality of data transfers with the highest scores or priorities without performing operations to maintain the structure of the maximum heap. Put another way, and using a specific example, in the implementation of FIG. 9B, to summarize the data transfer having the second greatest priority, the computer system 150 may be required to remove the root, restructure the maximum heap using the sink operation to maintain the structure of the heap, peek at the new root, add the former root back to the maximum heap, and restructure the maximum heap using the swim operation to maintain the structure of the heap.

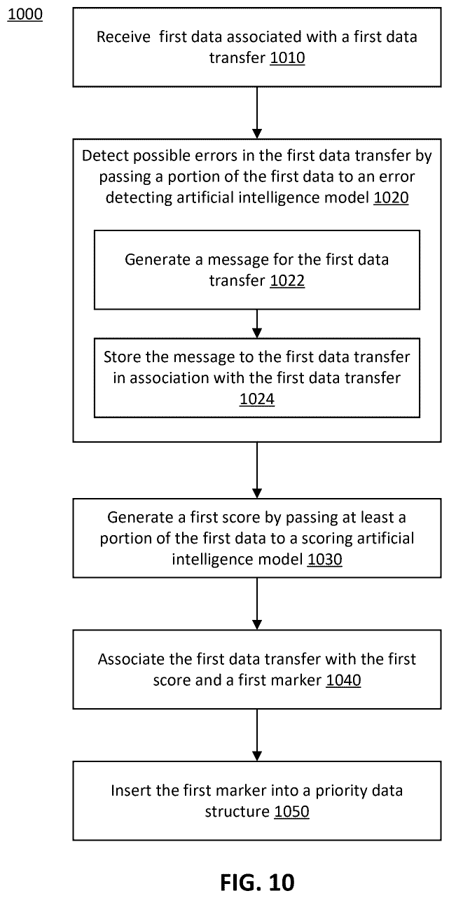

Reference is now be made to FIG. 10, which shows, in flowchart form, an example method 1000 for enhancing data transfer security. In particular, the method 1000 is a method involving scoring data transfers and placing a marker or pointer for those data transfers in a priority data structure. The method 1000 may be implemented by way of suitable programming processor-executable instructions stored in memory that, when executed by a processor such as the processor 310, cause a computing device to carry out the described functions as described above (see FIG. 3). As other examples, the method 1000 may be performed by another computing system, software application, a server, a cloud platform, a combination of systems, and the like.

The method 1000 begins with an operation 1010. At the operation 1010, the processor may receive first data associated with a first data transfer. The first data transfer may involve, for example, a client device receiving data such as network traffic. Additionally or alternatively, the first data transfer may involve a client device initiating transfer of a data resource to another device. The first data may include without limitation, the data being transferred, an address for the transferor, an address for the transferee, a virtual address for the transferor, a virtual address for the transferee, a time corresponding to initiation, transmission, or sending of the first data transfer, a time corresponding to reception of the first data transfer, a deadline, a text data associated with the first data transfer, and an amount of a data resource.

Following the operation 1010, flow control may proceed to an operation 1020. At the operation 1020, the processor may detect possible errors, defective data, or otherwise problematic data with respect to the first data transfer by passing at least a portion of the data associated with the first data transfer to an error detecting artificial intelligence model. The processor or computer system may also pass data not included in the first data to the error detecting artificial intelligence model. For example, a storage medium may store a data transfer history or historical data associated with a transferee or transferor or the data transferor. A portion of the historical data may also be passed to the error detecting artificial intelligence model.

In some embodiments, an error, defective data, or otherwise problematic data may relate to a transferee or transferor of the data transfer. For example, a storage medium may store a list of authorized, verified, or authenticated transferees or transferors and the transferor or transferee of the data transfer may not be found in this list. Additionally or alternatively, the transferee or transferor may be unidentifiable or nonexistent. In another example, a storage medium may store a list of addresses and identifiers associated with transferees and transferors. In particular, each address may match or map to an identifier. In this example, the data transfer may be considered to have an error, defective data, or otherwise problematic data if an address associated with a transferee associated with the data transfer does not match or map to a transferee identifier associated with the data transfer in the storage medium. That is, in the storage medium, the transferee address does not map to the transferee identifier. Another example of an error, defective data, or otherwise problematic data is if the data transfer involves a transfer of a data resource, a data resource account is associated with the transferee, and the amount of the data resource being transferred from the transferee in the data transfer is greater than the amount of the data resource associated in the associated account. Another example of an error, defective data, or otherwise problematic data is data indicating or reflecting that the data transfer diverges from a known data transfer history associated with the transferee or the transferor. Another example of an error, defective data, or otherwise problematic data is the transferee or transferor being a known bad actor. Examples of bad actors include without limitation criminal entities, fraudulent entities, and terrorist entities. In some embodiments, the error detecting artificial intelligence model may have been trained using data from a database of known bad actors.

The error detecting artificial intelligence model may output indications of possible errors, defective data, or otherwise problematic data. The indications may include text such as a message or error message specific to the first data transfer that describes the possible errors, defective data, or otherwise problematic data with respect to the first data transfer. Additionally or alternatively, the message or error message may describe possible solutions or corrections to remedy the possible errors, defective data, or otherwise problematic data.

The operation 1020 may be considered to include a suboperation 1022 and a suboperation 1024. At the suboperation 1022, the error detecting artificial intelligence model, or the processor via the error detecting artificial intelligence model, generates a message or error message specific to the first data transfer.

Following the suboperation 1022, flow control may proceed to a suboperation 1024. At the suboperation 1024, the processor may store, in association with the first data transfer, the message or error message generated for the first data transfer by the error detecting artificial intelligence model in a storage medium.

Following the operation 1020, flow control may proceed to an operation 1030. At the operation 1030 the processor may generate a first score by passing at least a portion of the first data to a scoring artificial intelligence model such as the scoring AI model 522 (see FIG. 5). The generated first score may reflect, indicate, or represent a priority or first priority associated with the first data transfer. In some embodiments, the processor may pass data generated in the operation 1020, or a portion thereof, to the scoring artificial intelligence model. For example, an error message generated by the error detecting artificial intelligence model may be passed to the scoring artificial intelligence model.

In some embodiments, the error detecting artificial intelligence model and the scoring artificial intelligence model may be the same artificial intelligence model. Further, while FIG. 10 depicts the operations 1020 and 1030 as separate, in some embodiments, the operations 1020 and 1030 may be executed or performed simultaneously or in a different order. For example, in some embodiments wherein the error detecting artificial intelligence model and the scoring artificial intelligence model are the same artificial intelligence model, the processor may generate a score and detect possible errors with one prompt or input to the artificial intelligence model.

While FIG. 10 depicts the operation 1030 as following the operation 1020, in some embodiments, the order may be reversed. In other embodiments, the operation 1020 and the operation 1030 may be performed simultaneously.

Following the operation 1030, flow control may proceed to an operation 1040. At the operation 1040, the processor may associate the first data transfer with the first score. The processor may further associate the first data transfer with a first marker or first pointer. The first marker or first pointer may be understood to be a pointer variable or reference variable that points to the first data, or alternatively, a storage address in a storage medium for the first data or the first data transfer. Additionally or alternatively, the first marker or first pointer may be considered to be an identifier or first identifier for the first data transfer or data associated with the first data transfer such as the first data or the first score. It may also be understood that by transitiveness, the first score is associated with the first marker or first pointer.

Following the operation 1040, flow control may proceed to an operation 1050. At the operation 1050, the processor may insert the first marker or first pointer into a priority data structure. The priority data structure may already contain or store a plurality of markers or pointers associated with respective data transfers associated with respective scores. In particular each of these already stored pointers or markers may be associated with a data transfer of which associated data has also been passed to the error detecting artificial intelligence model and the scoring artificial intelligence model. Moreover, each of these plurality of markers or pointers may also have an associated or related message or error message stored in a storage medium. That is, similar operations to the operations 1010-1030 may have been performed for the data transfers associated with the plurality of markers or pointers. Upon inserting the first marker or first pointer, the priority data structure may be considered to contain one or more pointers or markers associated with respective data transfers associated with respective scores. In particular, the first marker or first pointer may be considered a first one of the one or more markers or pointers. Further the first marker or pointer may be placed in the priority data structure based on the first score. For example, the priority data structure may be a queue that is sorted by the associated scores, or level or degree of priority reflected in or represented by the associated scores. In this example, the first marker or priority may be inserted into the priority data structure such that the sorted nature of the queue remains intact. Additionally or alternatively, the priority data structure may be implemented as a heap data structure and the addition or removal of a marker or pointer from the priority data structure may be implemented using standard sink and swim operations associated with heap data structures. The use of the priority data structure may have the benefit that data transfers are monitored or reviewed in order of priority.

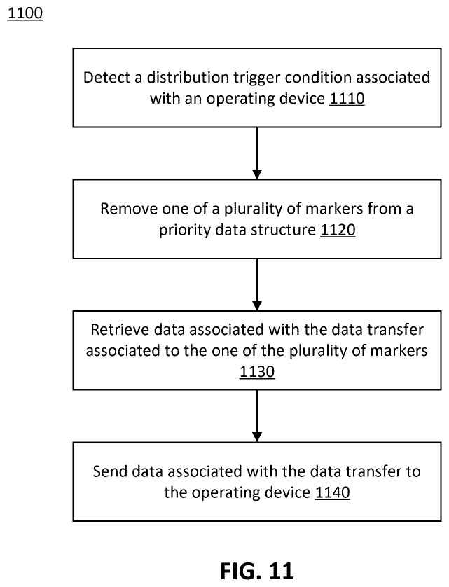

Reference is now be made to FIG. 11, which shows, in flowchart form, another example method 1100 for enhancing data transfer security. In particular, the method 1000 is a method related to distributing or sending a data transfer to an operating device, such as the operating device 130, for, for example, monitoring or review (see FIG. 5). In some circumstances, the method 1100 may be considered a continuation of the method 1000 (see FIG. 10). The method 1100 may be implemented by way of suitably programming processor-executable instructions stored in memory that, when executed by a processor such as the processor 310, cause a computing device to carry out the described functions as described above (see FIG. 3). As other examples, the method 1100 may be performed by another computing system, software application, a server, a cloud platform, a combination of systems, and the like.

The method 1100 begins with an operation 1110. At the operation 1110, the processor may detect a trigger condition or distribution trigger condition associated with an operating device such as the operating device 130. In some embodiments the distribution trigger condition may be receiving a request to distribute a data transfer to an operating device. In some embodiments, such a request may originate from the operating device. In other embodiments, the processor may monitor a workload of the operating device and initiate distribution of a data transfer to the operating device when the workload falls under or is less than a threshold. That is, the distribution trigger condition may be the workload of the operating device being less than the threshold. In some embodiment, the operating device may periodically update the processor with respect to the workload of the operating device. For example, upon a fixed amount of time elapsing, the processor may request that the operating device send data relating to the workload of the operating device to the processor or the computer system associated with the processor. In some embodiments the distribution trigger condition may be that the workload is zero.

Following the operation 1110, flow control may proceed to an operation 1120. Specifically, the processor may execute or perform the operation 1120 in response to the operation 1110. At the operation 1120, the processor may remove one of a plurality of markers or pointers from a priority data structure. That is, the processor may remove one of a plurality of markers or pointers from a priority data structure in response to detecting the distribution trigger condition. The priority data structure may be the same priority data structure as described with reference to the method 1000. Thus, the markers or pointers stored or maintained in the priority data structure may be associated with respective data transfers and respective scores. Moreover, the respective score associated with the one of the plurality of markers or pointers that is removed is representative, indicative, or reflective of a greater priority than the respective scores associated with a portion of, or another one of, the plurality of markers or pointers.

Following the operation 1120, flow control may proceed to an operation 1130. At the operation 1130, the processor may retrieve data associated with the removed marker or pointer from a storage medium. The retrieved data may include, for example, a respective message or error message for the respective data transfer associated with the removed marker or pointer that was generated in an operation similar to the suboperation 1022 (see FIG. 10).

Following the operation 1130, flow control may proceed to an operation 1140. At the operation 1130, the processor may send or distribute data associated with the respective data transfer associated with the removed marker or pointer to the operating device. This sent data may include the data retrieved in the operation 1130. In some embodiments, upon receiving the sent or distributed data, the operating device may present on a display of the operating device, a portion of the sent or distributed data. In some embodiments, the sent or displayed data may include the respective message or error message. For example, the message may read:
“This data transfer is atypical for the transferor. It diverges from a known data transfer history associated with the transferor.”

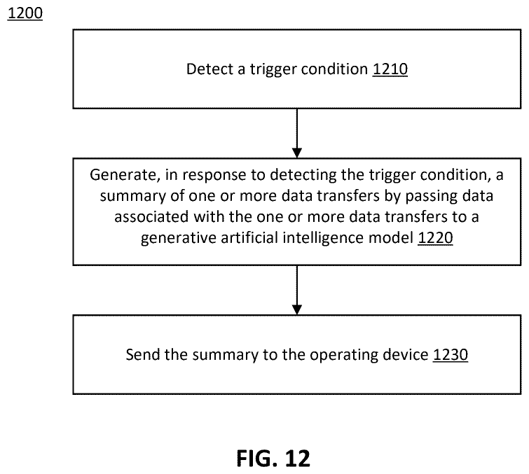

Reference is now be made to FIG. 12, which shows, in flowchart form, another example method 1200 for enhancing data transfer security. In particular, the method 1200 relates to generating summaries for data transfers. The method 1200 may be implemented by way of suitably programming processor-executable instructions stored in memory that, when executed by a processor such as the processor 310, cause a computing device to carry out the described functions as described above (see FIG. 3). As other examples, the method 1200 may be performed by another computing system, software application, a server, a cloud platform, a combination of systems, and the like.

In some circumstances, the method 1200 may be considered a continuation of the method 1000 (see FIG. 10). Specifically, in some circumstances, the processor may execute the method 1200 when the method 1000 or a similar method has been previously performed for at least one data transfer. Hence, as set up for the method 1200, there may be a priority data structure storing a plurality of markers or pointers associated with a plurality of data transfers. Data associated with these markers or data transfers may be stored in a storage medium. Further, a scoring artificial intelligence model may have generated scores for these markers and data transfers. Further, an error detecting artificial intelligence model may have generated a message or error message for each of these markers or data transfers. These messages or error message may be stored in a storage medium in association with respective or corresponding data transfers.

The method 1200 begins with an operation 1210. At the operation 1210, the processor may detect a trigger condition. A trigger condition may be, for example, receiving a request from an operating device such as the operating device 130 to generate a summary (see FIG. 5). Specifically, the summary requested may be a summary of data transfers associated with markers or pointers held or stored in the priority data structure. In some embodiments, the summary requested may be a summary of data transfers tracked in the priority data structure and having associated scores exceeding a threshold value. In some embodiments, the summary requested may be a summary of a portion of data transfers tracked in the priority data structure wherein the portion of data transfers have greater scores than the other data transfers tracked in the priority data structure.

Following the operation 1210, flow control may proceed to the operation 1220. At the operation 1220, the processor may, in response to detecting the trigger condition, generate a summary of data transfers associated with at least one of the plurality of markers or pointers held or stored in the priority data structure. In some embodiments, the at least one of the plurality of markers or pointers may correspond to data transfers having greater scores than the data transfers associated with the remainder of markers or pointers stored or held in the priority data structure. To this end, the processor may pass to a GenAI model and/or LLM, data associated with the data transfers associated with the at least one of the plurality of markers or pointers. For example, the processor may retrieve, from a storage medium, respective messages or error messages associated with the at least one of the plurality of markers or pointers. These messages or error messages may have been generated in an operation similar to the suboperation 1022 (see FIG. 10). These messages may be included in the data passed to the GenAI model.

The GenAI model may generate a summary or textual summary such as:
“7 high priority data transfers for review. 3 relate to a transferee identifier and a transferee address that do not match. 2 relate to a data resource transfer exceeding a data resource amount in a data account of the transferor. 1 relates to unusual or uncharacteristic data transfer behaviour of the transferor. 1 relates to the transferee being a known bad actor.”

Following the operation 1220, flow control may proceed to an operation 1230. At the operation 1230, the processor may send, to the operation device, the generated summary. In some embodiments, upon receiving the generated summary, the operating device, or a processor residing thereon, may present the summary on a display of the operating device.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computer system comprising:
at least one processor;
a memory coupled to the at least one processor and storing processor-executable instructions which, when executed by the at least one processor, configure the at least one processor to:
receive first data, the first data being associated with a first data transfer;
generate a first score by passing at least a portion of the first data to a scoring artificial intelligence model, the first score indicating a first priority;
associate the first data transfer with the first score;
associate the first data transfer with a first pointer;
insert the first pointer into a priority data structure that stores a plurality of pointers associated with respective data transfers and respective scores, the respective scores indicating respective priorities, the first pointer being placed in the priority data structure based on the first score;
detect a distribution trigger condition associated with an operating device;
remove, in response to detecting the distribution trigger condition, one pointer from the priority data structure, the respective score associated with the one pointer indicating a greater priority than the respective score associated with another pointer stored in the priority data structure; and
send data associated with the respective data transfer associated with the one pointer to the operating device.

2. The computer system of claim 1 wherein the at least one processor is further configured to use training data to train the scoring artificial intelligence model, the training data including a plurality of labelled pairs, at least one of the plurality of labelled pairs comprising:
sample data associated with a sample data transfer; and
a sample score.

3. The computer system of claim 1 wherein the at least one processor is further configured to use training data to train the scoring artificial intelligence model, the training data including a sorted list of sample data, the sample data being associated with sample data transfers having associated sample priorities, and the sorted list being sorted according to the associated sample priorities of the sample data transfers.

4. The computer system of claim 1 wherein the at least one processor is further configured to use training data to train the scoring artificial intelligence model, the training data including a plurality of labelled pairs, at least one of the plurality of labelled pairs comprising:
first sample data associated with a first sample data transfer; and
second sample data associated with a second sample data transfer, the second sample data transfer having a greater sample priority than the first sample data transfer.

5. The computer system of claim 1 wherein the at least one processor is further configured to:
generate, in association with the respective data transfer of the one pointer, a respective message specific to the respective data transfer by passing data associated with the respective data transfer to an error detecting artificial intelligence model; and
store, in a storage medium, the respective message in association with the respective data transfer.

6. The computer system of claim 5 wherein sending data associated with the respective data transfer associated with the one pointer to the operating device further comprises:
detecting that the one pointer has been removed from the priority data structure;
retrieving the respective message associated with the one pointer from the storage medium; and
sending the respective message to the operating device.

7. The computer system of claim 1 wherein the at least one processor is further configured to:
detect a trigger condition;
generate, in response to detecting the trigger condition, a summary of the respective data transfers associated with at least one of the pointers stored in the priority data structure by passing data associated with the respective data transfers associated with the at least one of the pointers to a generative artificial intelligence model; and
send the summary to the operating device.

8. The computer system of claim 7 wherein generating the summary further comprises:
prior to detecting the trigger condition, for one of the respective data transfers associated with the at least one of the pointers:
generating a respective message specific to the one of the respective data transfers by passing data associated with the one of the respective data transfer to an error detecting artificial intelligence model; and
storing, in a storage medium, the respective message in association with the one of the respective data transfers;
retrieving, in response to detecting the trigger condition, from the storage medium, the respective message associated with the one of the respective data transfers; and
including, in the data associated with the respective data transfers associated with the at least one of the pointers, the respective message.

9. The computer system of claim 5 wherein the processor is further configured to use error training data to train the error detecting artificial intelligence model, the error training data including a plurality of labelled pairs, at least one of the plurality of labelled pairs comprising:
first sample data corresponding to a sample data transfer with an error; and
second sample data corresponding to the sample data transfer with the error corrected.

10. The computer system of claim 5 wherein the processor is further configured to use error training data to train the error detecting artificial intelligence model, the error training data including a plurality of labelled pairs, at least one of the plurality of labelled pairs comprising:
first sample data corresponding to a sample data transfer with an error; and
second sample data corresponding to a description of the error.

11. The computer system of claim 5 wherein the scoring artificial intelligence model is the error detecting artificial intelligence model.

12. The computer system of claim 5 wherein the respective message indicates that the respective data transfer has an unidentifiable transferee.

13. The computer system of claim 5 wherein the respective message indicates that a transferee address associated with the respective data transfer fails to map to a transferee identifier associated with the respective data transfer.

14. A computer-implemented method comprising:
receiving first data, the first data being associated with a first data transfer;
generating a first score by passing at least a portion of the first data to a scoring artificial intelligence model, the first score indicating a first priority;
associating the first data transfer with the first score;
associating the first data transfer with a first pointer;
inserting the first pointer into a priority data structure that stores a plurality of pointers associated with respective data transfers and respective scores, the respective scores indicating respective priorities, the first pointer being placed in the priority data structure based on the first score;
detecting a distribution trigger condition associated with an operating device;
removing, in response to detecting the distribution trigger condition, one pointer from the priority data structure, the respective score associated with the one pointer indicating a greater priority than the respective score associated with another pointer stored in the priority data structure; and
sending data associated with the respective data transfer associated with the one pointer to the operating device.

15. The computer-implemented method of claim 14 wherein the method further comprises training the scoring artificial intelligence model using training data, the training data including a plurality of labelled pairs, at least one of the plurality of labelled pairs comprising:
sample data associated with a sample data transfer; and
a sample score.

16. The computer-implemented method of claim 14 wherein the method further comprises:
generating, in association with the respective data transfer of the one pointer, a respective message specific to the respective data transfer by passing data associated with the respective data transfer to an error detecting artificial intelligence model; and
storing, in a storage medium, the respective message in association with the respective data transfer.

17. The computer-implemented method of claim 16 wherein sending data associated with the respective data transfer associated with the one pointer to the operating device further comprises:
detecting that the one pointer has been removed from the priority data structure;
retrieving the respective message associated with the one pointer from the storage medium; and
sending the respective message to the operating device.

18. The computer-implemented method of claim 14 wherein the method further comprises:
detecting a trigger condition;
generating, in response to detecting the trigger condition, a summary of the respective data transfers associated with at least one of the pointers stored in the priority data structure by passing data associated with the respective data transfers associated with the at least one of the pointers to a generative artificial intelligence model; and
sending the summary to the operating device.

19. The computer-implemented method of claim 18 wherein generating the summary further comprises:
prior to detecting the trigger condition, for one of the respective data transfers associated with the at least one of the pointers:
generating a respective message specific to the one of the respective data transfers by passing data associated with the one of the respective data transfers to an error detecting artificial intelligence model; and
storing, in a storage medium, the respective message in association with the one of the respective data transfers;
retrieving, in response to detecting the trigger condition, from the storage medium, the respective messages associated with the one of the respective transfers; and
including, in the data associated with the respective data transfers associated with the at least one of the pointers, the respective message.

20. A computer-readable medium comprising instructions stored therein which, when executed by a processor, cause a computer to:
receive first data, the first data being associated with a first data transfer;
generate a first score by passing at least a portion of the first data to a scoring artificial intelligence model, the first score indicating a first priority;
associate the first data transfer with the first score;
associate the first data transfer with a first pointer;
insert the first pointer into a priority data structure that stores a plurality of pointers associated with respective data transfers and respective scores, the respective scores indicating respective priorities, the first pointer being placed in the priority data structure based on the first score;
detect a distribution trigger condition associated with an operating device;
remove, in response to detecting the distribution trigger condition, one pointer from the priority data structure, the respective score associated with the one pointer indicating a greater priority than the respective score associated with another pointer stored in the priority data structure; and
send data associated with the respective data transfer associated with the one pointer to the operating device.
